(19) United States
(12) Patent Application Publication
(10) Pub. No.: US 2023/0024838 A1
(43) Pub. Date: Jan. 26, 2023

(54) APPARATUS FOR PREDICTING TRAFFIC INFORMATION AND METHOD THEREOF

(71) Applicants: Hyundai Motor Company, Seoul (KR); Kia Corporation, Seoul (KR)

(72) Inventor: Tae Heon Kim, Siheung (KR)

(21) Appl. No.: 17/668,877

(22) Filed: Feb. 10, 2022

(30) Foreign Application Priority Data
Jul. 14, 2021 (KR) 10-2021-0092504

(51) Int. Cl. G08G 1/01; G08G 1/052; G08G 1/0967

(52) U.S. Cl. CPC G08G 1/0129; G08G 1/0133; G08G 1/0112; G08G 1/052; G08G 1/096791

(57) ABSTRACT

An apparatus for predicting traffic information includes a storage storing a traffic information prediction model, and a controller configured to calculate a congestion transfer rate W_{AB} of a target section based on a volume of traffic and vehicle density and input the congestion transfer rate, a speed of the target section, a speed of a section in front of the target section, and a speed of a section behind the target section to the traffic information prediction model to estimate traffic information of the target section.

### CROSS-REFERENCE TO RELATED APPLICATION

This application claims under 35 U.S.C. § 119(a) the benefit of Korean Patent Application No. 10-2021-0092504, filed in the Korean Intellectual Property Office on Jul. 14, 2021, the entire contents of which are incorporated herein by reference.

### BACKGROUND

### (a) Technical Field

The present disclosure relates to an apparatus and method of predicting traffic information using a model, more particularly, to the apparatus and method of predicting traffic information that utilize a traffic information prediction model incorporating congestion transfer rate based machine learning.

### (b) Description of the Related Art

Traffic information currently provided corresponds to information predicted based on a past speed pattern. In other words, current traffic information, for example, speed information, is derived using a previous speed pattern on the assumption that a similar speed will be generated at the same time of day.

When traffic information is used on the same day and time period in the past, for example, a speed from 9:00 AM to 9:05 AM on Monday, March 2 is predicted using a speed of 9:00 AM to 9:05 AM Monday, February 3 and a speed of 9:00 AM to 9:05 AM Monday, February 10.

However, because exceptions capable of being shown at a corresponding time point, for example, variables such as weather or seasons, may differently vary in the speed according to the past pattern and because the volume of traffic may vary for each time, unsuitable data according may be used for speed prediction. In other words, there is a high possibility that the assumption that a similar speed will be maintained in the same time period will increase a probability that an error will occur when traffic information is predicted.

Meanwhile, research is being conducted on whether changes in the amount of driving of a vehicle probe (hereinafter referred to as a “probe”) affect transportation to predict traffic information. In this case, it is able to predict a congestion time macroscopically on the basis of the time of GPS occurrence, but there are limitations in prediction in microscopic aspects such as speed prediction for each time period in units of links (the road to be predicted) due to a limit to the number of probe samples.

Thus, there is a need to use a speed of a similar traffic state, rather than a simple speed in the same time period, when the past pattern speed is used. Meanwhile, density corresponding to vehicle density is known as an effective measure capable of most objectively determining a traffic state in traffic engineering.

Research about density estimation may calculate the number of average vehicles of a corresponding section by capturing an image of the road of a limited section and may identify the number of all vehicles on the real road by image capture, but has limitations in ensuring data, when density data is always needed, for example, upon traffic prediction.

Details described in the background art are written to increase the understanding of the background of the present disclosure, which may include details rather than an existing technology well known to those skilled in the art.

### SUMMARY

An aspect of the present disclosure provides an apparatus for predicting traffic information to calculate a congestion transfer rate of a target section based on traffic volume information and density information, learn a traffic information prediction model using the congestion transfer rate, a speed of the target section, a speed of a section in front of the target section, and a speed of a section behind the target section, and predict traffic information of the target section based on the traffic information prediction model to predict traffic information to have high accuracy in a traffic situation different from the past and a method thereof

The purposes of the present disclosure are not limited to the aforementioned purposes, and any other purposes and advantages not mentioned herein will be clearly understood from the following description and may more clearly known by an embodiment of the present disclosure. Furthermore, it may be easily seen that purposes and advantages of the present disclosure may be implemented by devices and/or methods indicated in claims and a combination thereof

According to an aspect of the present disclosure, an apparatus for predicting traffic information may include a storage storing a traffic information prediction model and a controller that calculates a congestion transfer rate W_{AB} of a target section based on a volume of traffic and vehicle density and inputs the congestion transfer rate, a speed of the target section, a speed of a section in front of the target section, and a speed of a section behind the target section to the traffic information prediction model to estimate traffic information of the target section.

In an embodiment of the present disclosure, the controller may calculate the congestion transfer rate.

In an embodiment of the present disclosure, the storage may further store a traffic volume estimation model.

In an embodiment of the present disclosure, the controller may estimate a volume of traffic on the target section corresponding to the number of probe vehicles passing through a specific point of the target section during a reference time, based on the traffic volume estimation model.

In an embodiment of the present disclosure, the controller may calculate the vehicle density based on a headway.

In an embodiment of the present disclosure, the controller may calculate the headway using a gap between a probe vehicle and a preceding vehicle and a length of the preceding vehicle.

In an embodiment of the present disclosure, the controller may calculate the vehicle density based on Equation 4 below.

In an embodiment of the present disclosure, the traffic information may include at least one of an average passing speed of the target section or a time taken to pass through the target section.

According to another aspect of the present disclosure, a method for predicting traffic information may include storing, by a storage, a traffic information prediction model, calculating, by a controller, a congestion transfer rate W_{AB} of a target section based on a volume of traffic and vehicle density, and inputting, by controller, the congestion transfer rate, a speed of the target section, a speed of a section in front of the target section, and a speed of a section behind the target section to the traffic information prediction model to estimate traffic information of the target section.

In an embodiment of the present disclosure, the calculating of the congestion transfer rate may include calculating the congestion transfer rate.

In an embodiment of the present disclosure, the method may further include storing, by the storage, a traffic volume estimation model.

In an embodiment of the present disclosure, the calculating of the congestion transfer rate may include estimating a volume of traffic on the target section corresponding to the number of probe vehicles passing through a specific point of the target section during a reference time, based on the traffic volume estimation model.

In an embodiment of the present disclosure, the calculating of the congestion transfer rate may include calculating a headway using a gap between a probe vehicle and a preceding vehicle and a length of the preceding vehicle and calculating the vehicle density based on the headway.

In an embodiment of the present disclosure, the calculating of the vehicle density may include calculating the vehicle density.

In an embodiment of the present disclosure, the method may further include outputting, by an output device, the traffic information.

### BRIEF DESCRIPTION OF THE DRAWINGS

The above and other objects, features and advantages of the present disclosure will be more apparent from the following detailed description taken in conjunction with the accompanying drawings

FIG. 1 is a block diagram illustrating a configuration of an apparatus for predicting traffic information according to an embodiment of the present disclosure;

FIG. 2 is a drawing illustrating a traffic volume estimation model stored in a storage provided in an apparatus for predicting traffic information according to an embodiment of the present disclosure;

FIG. 3 is a drawing illustrating a process of calculating a headway in a controller provided in an apparatus for predicting traffic information according to an embodiment of the present disclosure;

FIG. 4 is a drawing illustrating a process of estimating density based on a headway in a controller provided in an apparatus for predicting traffic information according to an embodiment of the present disclosure;

FIG. 5 is a drawing illustrating a process of calculating a congestion transfer rate of a target section in a controller provided in an apparatus for predicting traffic information according to an embodiment of the present disclosure;

FIG. 6 is a flowchart illustrating a method for predicting traffic information according to an embodiment of the present disclosure; and

FIG. 7 is a block diagram illustrating a computing system for executing a method for predicting traffic information according to an embodiment of the present disclosure.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Hereinafter, some embodiments of the present disclosure will be described in detail with reference to the accompanying drawings. In adding the reference numerals to the components of each drawing, it should be noted that the identical component is designated by the identical numerals even when they are displayed on other drawings. Further, in describing the embodiment of the present disclosure, a detailed description of well-known features or functions will be ruled out in order not to unnecessarily obscure the gist of the present disclosure.

In describing the components of the embodiment according to the present disclosure, terms such as first, second, “A”, “B”, (a), (b), and the like may be used. These terms are merely intended to distinguish one component from another component, and the terms do not limit the nature, sequence or order of the constituent components. Furthermore, unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

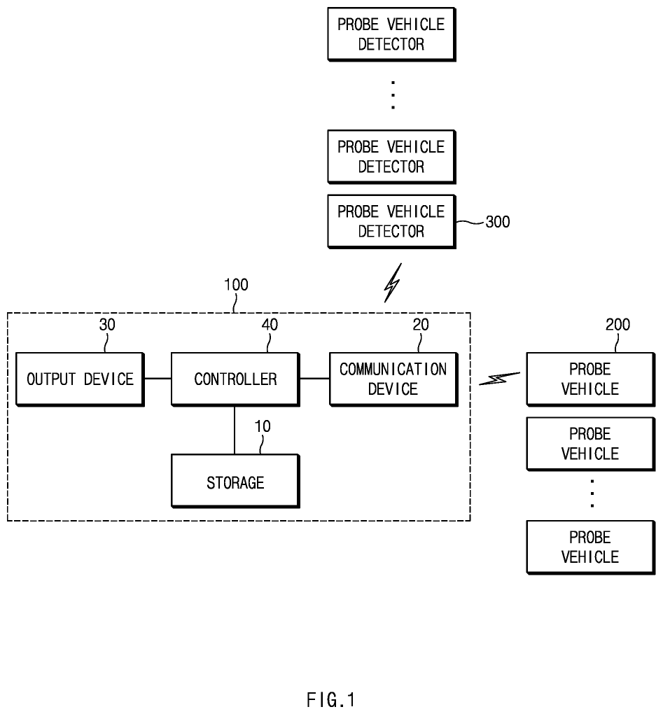

FIG. 1 is a block diagram illustrating a configuration of an apparatus for predicting traffic information according to an embodiment of the present disclosure.

As shown in FIG. 1, an apparatus 100 for predicting traffic information according to an embodiment of the present disclosure may include a storage 10, a communication device 20, an output device 30, and a controller 40. In this case, the respective components may be combined into one component and some components may be omitted, depending on a manner which executes the apparatus 100 for predicting the traffic information according to an embodiment of the present disclosure.

Seeing the respective components, first of all, the storage 10 may store various logic, algorithms, and programs required in a process of calculating a congestion transfer rate of a target section based on traffic volume information and density information, learning a traffic information prediction model using the congestion transfer rate, a speed of the target section, a speed of a section in front of the target section, and a speed of a section behind the target section, and predicting traffic information of the target section based on the traffic information prediction model.

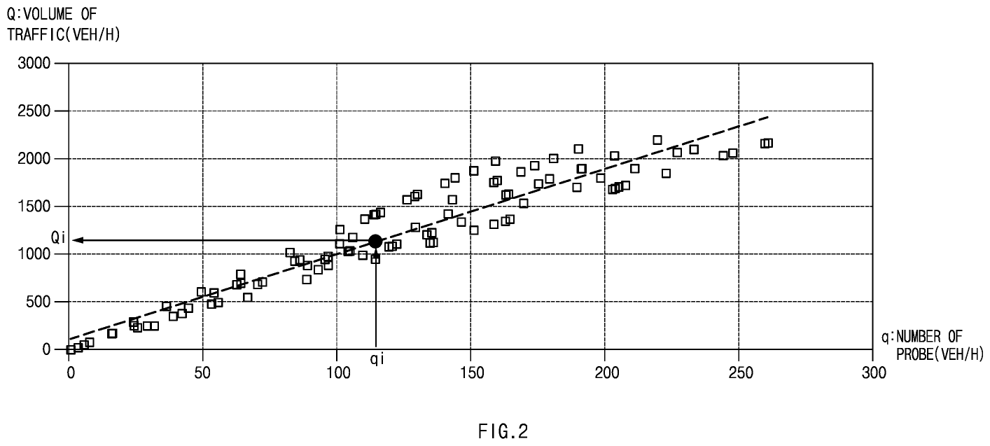

The storage 10 may store a traffic volume estimation model used to estimate a volume of traffic volume on the target section based on the number of probe vehicles passing through a specific point of the target section during a reference time (e.g., 1 hour). An example of such a traffic volume estimation model is as shown in FIG. 2.

FIG. 2 is a drawing illustrating a traffic volume estimation model stored in a storage provided in an apparatus for predicting traffic information according to an embodiment of the present disclosure. The horizontal axis indicates the number of probe vehicles, and the vertical axis indicates the volume of traffic. For example, when the number of probe vehicles 200 passing through a specific point of a target section during a reference time (e.g., 1 hour) is qᵢ, a volume of traffic volume on the target section may be Qᵢ.

Such a traffic volume estimation model may be generated by performing a regression analysis of the number of probe vehicles 200 detected by a probe vehicle detector 300 of FIG. 1 and the number of general vehicles (service subscription vehicles) specified as the probe vehicles 200.

The storage 10 may store logic used to calculate a headway based on probe data received from the probe vehicle 200 and calculate vehicle density based on the headway.

Such a storage 10 may include at least one type of storage medium, such as a flash memory type memory, a hard disk type memory, a micro type memory, a card type memory (e.g., a secure digital (SD) card or an extreme digital (XD) card), a random access memory (RAM), a static RAM (SRAM), a read-only memory (ROM), a programmable ROM (PROM), an electrically erasable PROM (EEPROM), a magnetic RAM (MRAM), a magnetic disk, and an optical disk

The communication device 20 may be a module for providing a communication interface with the probe vehicle 200 traveling on the road and a communication interface with a probe vehicle detector 300 located at a specific point on the road, which may periodically receive probe data from the probe vehicle 200 and the probe vehicle detector 300. In this case, the probe data received from the probe vehicle 200 by the communication device 20 may include identification information (an ID), a driving speed, a position (e.g., a global positioning system (GPS) position), a length of a preceding vehicle, a gap between the probe vehicle 200 and the preceding vehicle, or a gap between the probe vehicle 200 and a following vehicle. The probe data received from the probe vehicle detector 300 by the communication device 20 may include identification information (an ID), a driving speed, a length of a preceding vehicle, a gap between the probe vehicle 200 and the preceding vehicle, or a gap between the probe vehicle 200 and a following vehicle. Such a probe vehicle 200 may have a telematics terminal as a vehicle terminal Furthermore, the probe vehicle 200 may obtain a gap between the probe vehicle 200 and a preceding vehicle by a front sensor, may obtain a gap between the probe vehicle 200 and a following vehicle by a rear sensor, and may obtain a length of the preceding vehicle by a front view camera. In this case, the probe vehicle 200 may distinguish a vehicle type (e.g., a passenger vehicle, a van, an SUV, a truck, or the like) according to a rear shape or a side shape of the preceding vehicle and may previously store a length according to the vehicle type.

Such a communication device 20 may include at least one of a mobile communication module, a wireless Internet module, or a short-range communication module for communicating with the probe vehicle 200 and the probe vehicle detector 300.

The mobile communication module may communicate with the probe vehicle 200 and the probe vehicle detector 300 over a mobile communication network established according to technical standards for mobile communication or a communication scheme (e.g., global system for mobile communication (GSM), code division multi access (CDMA), code division multi access 2000 (CDMA2000), enhanced voice-data optimized or enhanced voice-data only (EV-DO), wideband CDMA (WCDMA), high speed downlink packet access (HSDPA), high speed uplink packet access (HSUPA), long term evolution (LTE), long term evolution-advanced (LTE-A), or the like), 4th generation (4G) mobile telecommunication, or 5th generation (5G) mobile telecommunication.

The wireless Internet module may be a module for wireless Internet access, which may communicate with the probe vehicle 200 and the probe vehicle detector 300 through wireless LAN (WLAN), wireless-fidelity (Wi-Fi), Wi-Fi Direct, digital living network alliance (DLNA), wireless broadband (WiBro), world interoperability for microwave access (WiMAX), high speed downlink packet access (HSDPA), high speed uplink packet access (HSUPA), long term evolution (LTE), long term evolution-advanced (LTE-A), or the like.

The short-range communication module may support short-range communication using at least one of Bluetooth™, radio frequency identification (RFID), infrared data association (IrDA), ultra wideband (UWB), ZigBee, near field communication (NFC), and wireless universal serial bus (USB) technologies.

An output device 30 of FIG. 1 may provide a user with traffic information of a target section predicted by a controller 40 of FIG. 1. In this case, the traffic information may include a passing speed (an average speed) of the target section, a minimum speed of the target section, a maximum speed of the target section, a time taken to pass through the target section, or the like.

The controller 40 may perform the overall control such that respective components may normally perform their own functions. Such a controller 40 may be implemented in the form of hardware, may be implemented in the form of software, or may be implemented in the form of a combination thereof Preferably, the controller 40 may be implemented as, but not limited to, a microprocessor.

Particularly, the controller 40 may perform a variety of control in a process of calculating a congestion transfer rate of a target section based on traffic volume information and density information, learning a traffic information prediction model using the congestion transfer rate, a speed of the target section, a speed of a section in front of the target section, and a speed of a section behind the target section, and predicting traffic information of the target section based on the traffic information prediction model. In this case, the controller 40 may detect the speed of the target section, the speed of the section in front of the target section, and the speed of the section behind the target section based on the probe data.

The controller 40 may estimate a volume of traffic corresponding to the number of probe vehicles 200 passing through a specific point of the target section during a reference time (e.g., 1 hour), based on a traffic volume estimation model stored in the storage 10.

The controller 40 may estimate density (e.g., vehicle density) of the target section based on probe data obtained from the probe vehicle 200 and the probe vehicle detector 300. In other words, the controller 40 may calculate a headway based on the probe data and may calculate density based on the headway.

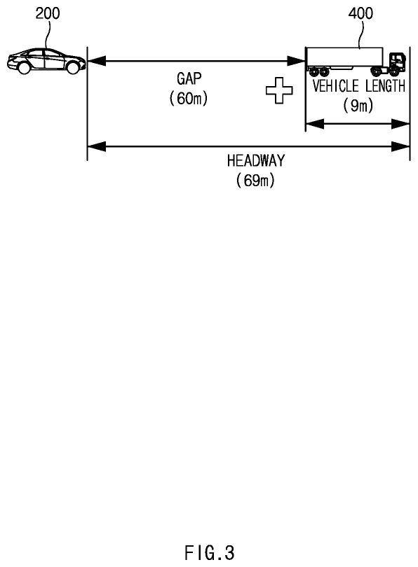

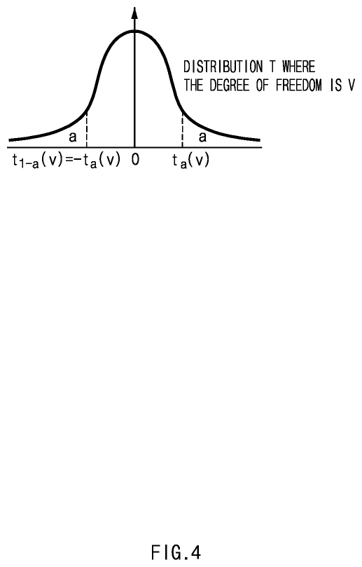

Hereinafter, the process of estimating the density in the controller 40 will be described in detail with reference to FIGS. 3 and 4.

FIG. 3 is a drawing illustrating a process of calculating a headway in a controller provided in an apparatus for predicting traffic information according to an embodiment of the present disclosure. FIG. 4 is a drawing illustrating a process of estimating density based on a headway in a controller provided in an apparatus for predicting traffic information according to an embodiment of the present disclosure.

As shown in FIG. 3, a controller 40 of FIG. 1 may calculate a headway based on a gap between a probe vehicle 200 and a preceding vehicle 400, which is received from the probe vehicle 200, and a length of the preceding vehicle 400. In other words, the controller 40 may calculate the headway by adding the gap between the probe vehicle 200 and the preceding vehicle 400 and the length of the preceding vehicle 400. For example, when the gap between the probe vehicle 200 and the preceding vehicle 400 is 60 m and when the length of the preceding vehicle 400 is 9 m, the headway becomes 60 m (60 m+9 m).

Thereafter, the controller 40 may estimate an average headway of a population by N samples of a plurality of headways received from the plurality of probe vehicles 200. In this case, when the number of samples of headways is N, when an average of the N samples of the headways is E(x), and when a standard deviation of the N samples of the headways is s, an average headway μ of the population may be pu as a statistic T following distribution t Such a statistic T may be represented as Equation 1 below.

$$T = \frac{( E ( X ) - μ ) \sqrt{N - 1}}{s} \qquad [ Equation 1 ]$$

Herein, Equation 1 above may be represented as a graph as shown in FIG. 4. In FIG. 4, when the degree of freedom is N−1 and when a limit value for 95% confidence level is a, T may be ep sented as Equation 2 below for a. In this case, the average headway g of the population may be represented as Equation 3 below having the range of a to b.

−α≤T≤α [Equation 2]

a≤μ≤b [Equation 3]

When the average headway μ of the population is derived as Equation 3 above, the controller 40 may derive a density K of a specific section having a specific length like Equation 4 below.

$$\frac{L}{b} \leq K \leq \frac{L}{a} \qquad [ Equation 4 ]$$

Herein, L denotes the length of the specific section, a denotes the minimum value of the average headway μ of the population, and b denotes the maximum value of the average headway μ of the population.

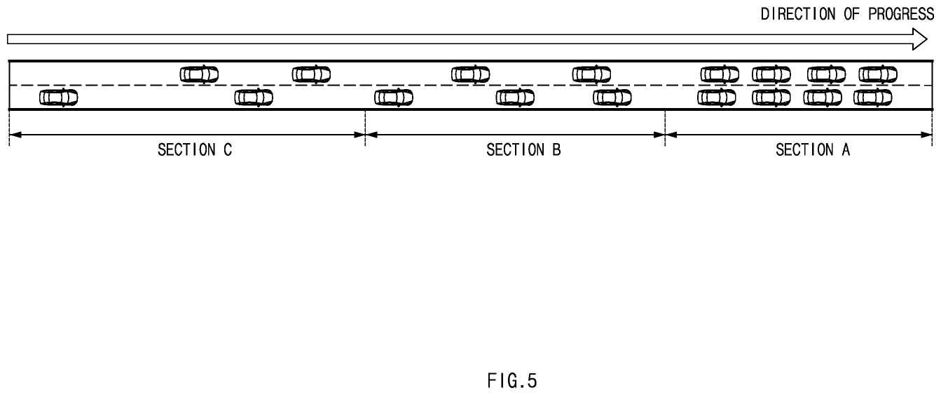

Meanwhile, as shown in FIG. 5, the controller 40 may calculate a congestion transfer rate of the target section based on the volume of traffic and density.

FIG. 5 is a drawing illustrating a process of calculating a congestion transfer rate of a target section in a controller provided in an apparatus for predicting traffic information according to an embodiment of the present disclosure.

In FIG. 5, section A denotes the section where congestion occurs, section B denotes the target section, and section C denotes the following section of the target section.

A controller 40 of FIG. 1 may estimate a volume of traffic (the number of vehicles/h) corresponding to the number of probe vehicles 200 on section A, may estimate a volume of traffic corresponding to the number of probe vehicles 200 on section B, and may detect a density (the number of vehicles/km) of section A, and may detect a density of section B.

Thereafter, the controller 40 may calculate a speed at which congestion is transferred from section A to section B (hereinafter, referred to as a congestion transfer rate of section B) based on Equation 5 below.

$${W}_{AB} = \frac{{q}_{A} - {q}_{B}}{{k}_{A} - {k}_{B}} \qquad [ Equation 5 ]$$

Herein, q_{A} denotes the volume of traffic on section A, q_{B} denotes the volume of traffic on section B, k_{A} denotes the density of section A, and kB denotes the density of section B. As an example, when q_{A} is 800, q_{B} is 1200, k_{A} is 50, and k_{B} is 30, the congestion transfer rate of section B becomes −20 km/h.

Thereafter, the controller 40 may calculate a speed (an average passing speed) of section A, a speed of section B, and a speed of section C based on probe data.

Thereafter, the controller 40 may estimate traffic information of section B corresponding to the congestion transfer rate of section B, the speed of section A, the speed of section B, and the speed of section C, based on a traffic information prediction model, machine learning of which is completed. In this case, the traffic information may be traffic information of section B within a certain time (e.g., 2 hours) from a current time point, which may include an average passing speed of section B or a time taken to pass through section B.

Meanwhile, when receiving a congestion transfer rate of a target section, a speed of the target section, a speed of a section in front of the target section, and a speed of a section behind the target section, the controller 40 may learn the traffic information prediction model to output prediction traffic information of the target section. Herein, the controller 40 may implement the traffic information prediction model as a random forest. In this case, an objective function may set root mean square error (RMSE) or parameter tuning to random search and may set validation to cross validation (k:10).

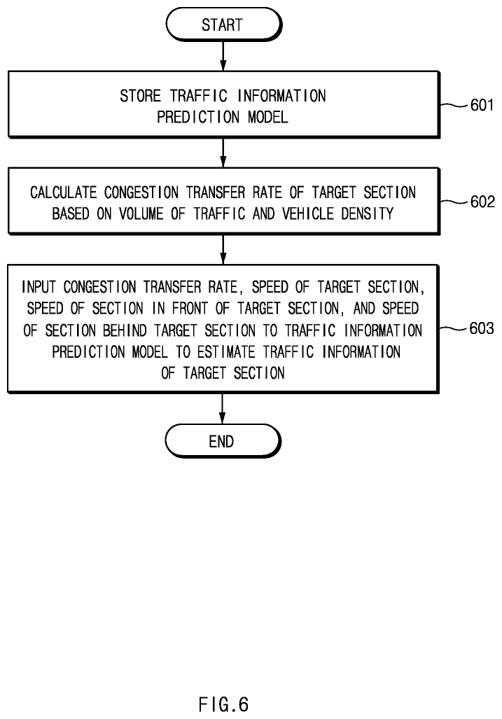

FIG. 6 is a flowchart illustrating a method for predicting traffic information according to an embodiment of the present disclosure.

First of all, in operation 601, a storage 10 of FIG. 1 may store a traffic information prediction model.

In operation 602, a controller 40 of FIG. 1 may calculate a congestion transfer rate of a target section based on a volume of traffic and vehicle density.

In operation 603, the controller 40 may input the congestion transfer rate, a speed of the target section, a speed of a section in front of the target section, and a speed of a section behind the target section to the traffic information prediction model to estimate traffic information of the target section.

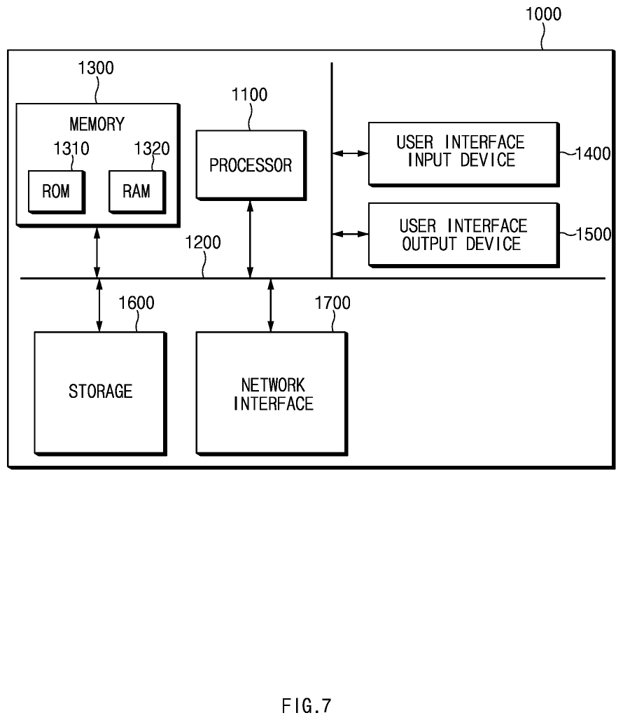

FIG. 7 is a block diagram illustrating a computing system for executing a method for predicting traffic information according to an embodiment of the present disclosure.

Referring to FIG. 7, the above-mentioned method for predicting the traffic information according to an embodiment of the present disclosure may be implemented by the computing system. A computing system 1000 may include at least one processor 1100, a memory 1300, a user interface input device 1400, a user interface output device 1500, storage 1600, and a network interface 1700, which are connected with each other via a system bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a ROM (Read Only Memory) 1310 and a RAM (Random Access Memory) 1320.

Thus, the operations of the method or the algorithm described in connection with the embodiments disclosed herein may be embodied directly in hardware or a software module executed by the processor 1100, or in a combination thereof. The software module may reside on a storage medium (that is, the memory 1300 and/or the storage 1600) such as a RAM, a flash memory, a ROM, an EPROM, an EEPROM, a register, a hard disk, a SSD (Solid State Drive), a removable disk, and a CD-ROM. The exemplary storage medium may be coupled to the processor 1100. The processor 1100 may read out information from the storage medium and may write information in the storage medium. Alternatively, the storage medium may be integrated with the processor 1100. The processor and the storage medium may reside in an application specific integrated circuit (ASIC). The ASIC may reside within a user terminal. In another case, the processor and the storage medium may reside in the user terminal as separate components.

The apparatus for predicting the traffic information and the method thereof according to an embodiment of the present disclosure may be provided to calculate a congestion transfer rate of a target section based on traffic volume information and density information, learn a traffic information prediction model using the congestion transfer rate, a speed of the target section, a speed of a section in front of the target section, and a speed of a section behind the target section, and predict traffic information of the target section based on the traffic information prediction model, thus predicting traffic information to have high accuracy in a traffic situation different from the past.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

Therefore, the exemplary embodiments of the present disclosure are provided to explain the spirit and scope of the present disclosure, but not to limit them, so that the spirit and scope of the present disclosure is not limited by the embodiments. The scope of the present disclosure should be construed on the basis of the accompanying claims, and all the technical ideas within the scope equivalent to the claims should be included in the scope of the present disclosure.

What is claimed is:

1. An apparatus for predicting traffic information, the apparatus comprising:
a storage storing a traffic information prediction model; and
a controller configured to calculate a congestion transfer rate W_{AB} of a target section based on a volume of traffic and vehicle density and input the congestion transfer rate, a speed of the target section, a speed of a section in front of the target section, and a speed of a section behind the target section to the traffic information prediction model to estimate traffic information of the target section.

2. The apparatus of claim 1, wherein the controller calculates the congestion transfer rate W_{AB} based on the following equation:
$${W}_{A B} = \frac{{q}_{A} - {q}_{B}}{{k}_{A} - {k}_{B}}$$
wherein q_{A} denotes the volume of traffic on the section behind the target section, q_{B} denotes the volume of traffic on the target section, k_{A} denotes the density of the section behind the target section, and k_{B} denotes the density of the target section.

3. The apparatus of claim 1, wherein the storage further stores a traffic volume estimation model.

4. The apparatus of claim 3, wherein the controller estimates a volume of traffic on the target section corresponding to the number of probe vehicles passing through a specific point of the target section during a reference time, based on the traffic volume estimation model.

5. The apparatus of claim 1, wherein the controller calculates the vehicle density based on a headway.

6. The apparatus of claim 5, wherein the controller calculates the headway using a gap between a probe vehicle and a preceding vehicle and a length of the preceding vehicle.

7. The apparatus of claim 5, wherein the controller calculates the vehicle density based on the following equation:
$$\frac{L}{b} \leq K \leq \frac{L}{a}$$
wherein L denotes the length of the target section, a denotes the minimum value of the average headway μ of the population, and b denotes the maximum value of the average headway μ of the population.

8. The apparatus of claim 1, wherein the traffic information includes at least one of an average passing speed of the target section or a time taken to pass through the target section.

9. The apparatus of claim 1, further comprising:
an output device configured to output the traffic information.

10. A method for predicting traffic information, the method comprising:
storing, by a storage, a traffic information prediction model;
calculating, by a controller, a congestion transfer rate W_{AB} of a target section based on a volume of traffic and vehicle density; and
inputting, by controller, the congestion transfer rate, a speed of the target section, a speed of a section in front of the target section, and a speed of a section behind the target section to the traffic information prediction model to estimate traffic information of the target section.

11. The method of claim 10, wherein calculating the congestion transfer rate includes:
calculating the congestion transfer rate W_{AB} based on the following equation:
$${W}_{A B} = \frac{{q}_{A} - {q}_{B}}{{k}_{A} - {k}_{B}}$$
wherein q_{A} denotes the volume of traffic on the section behind the target section, q_{B} denotes the volume of traffic on the target section, k_{A} denotes the density of the section behind the target section, and k_{B} denotes the density of the target section.

12. The method of claim 10, further comprising:
storing, by the storage, a traffic volume estimation model.

13. The method of claim 12, wherein calculating the congestion transfer rate includes:
estimating a volume of traffic on the target section corresponding to the number of probe vehicles passing through a specific point of the target section during a reference time, based on the traffic volume estimation model.

14. The method of claim 10, wherein calculating the congestion transfer rate includes:
calculating a headway using a gap between a probe vehicle and a preceding vehicle and a length of the preceding vehicle; and
calculating the vehicle density based on the headway.

15. The method of claim 14, wherein calculating the vehicle density includes:
calculating the vehicle density based on the following equation:
$$\frac{L}{b} \leq K \leq \frac{L}{a}$$
wherein L denotes the length of the target section, a denotes the minimum value of the average headway μ of the population, and b denotes the maximum value of the average headway μ of the population.

16. The method of claim 10, wherein the traffic information includes at least one of an average passing speed of the target section or a time taken to pass through the target section.

17. The method of claim 10, further comprising:
outputting, by an output device, the traffic information.
